(19) United States
(12) Patent Application Publication
(10) Pub. No.: US 2011/0069009 A1
(43) Pub. Date: Mar. 24, 2011

(54) ELECTRONIC DEVICE WITH CURSOR CONTROLLING APPARATUS

(75) Inventor: CHOON-TYNG LAU, Tu-Cheng (TW)

(73) Assignee: HON HAI PRECISION INDUSTRY CO., LTD., Tu-Cheng (TW)

(21) Appl. No.: 12/621,135

(22) Filed: Nov. 18, 2009

(30) Foreign Application Priority Data
Sep. 21, 2009 (CN) 200910307388.9

(51) Int. Cl. G06F 3/033

(52) U.S. Cl. 345/166; 345/163; 345/173

(57) ABSTRACT

An apparatus includes an electronic device. The electronic device includes a cursor controlling apparatus which is detachably mounted to the electronic device. The cursor controlling apparatus includes a touchpad mounted on a top portion of the cursor controlling apparatus, a mouse module mounted in the cursor controlling apparatus, and a controller connected to the touchpad and the mouse module. The controller is capable of detecting whether the cursor controlling apparatus is mounted to the electronic device. The controller enables the touchpad and disables the mouse module when the controller detects the cursor controlling apparatus is mounted to the electronic device. The controller enables the mouse module and disables the touchpad when the controller detects the cursor controlling apparatus is not mounted to the electronic device.

### BACKGROUND

1. Technical Field

The present disclosure relates to electronic devices, and particularly to an electronic device having cursor controlling apparatus.

2. Description of Related Art

Some electronic devices, such as notebook computers, are equipped with a touchpad for controlling a cursor on a display of the device. The touchpad performs many of the same scrolling and cursor positioning functions as a mouse. However, this is not a satisfactory solution for many applications. For example, while a compact trackball or touchpad emulates some mouse functions, especially in graphics applications where the user “clicks” and “drags” line segments to create drawings. Compared to the touchpad, a mouse has the advantage that it can be easily moved over a comparatively large area with a high level of control. However, it is inconvenient to carry a mouse along with a portable electronic device.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an electronic device which includes a cursor controlling apparatus.

FIG. 2 is an isometric view of the cursor controlling apparatus of FIG. 1.

FIG. 3 is a block view of the cursor controlling apparatus of FIG. 1.

FIG. 4 is an assembled view of the electronic device of FIG. 1.

FIG. 5 is an isometric view of another embodiment of the cursor controlling apparatus.

FIG. 6 is a block view of the cursor controlling apparatus of FIG. 5.

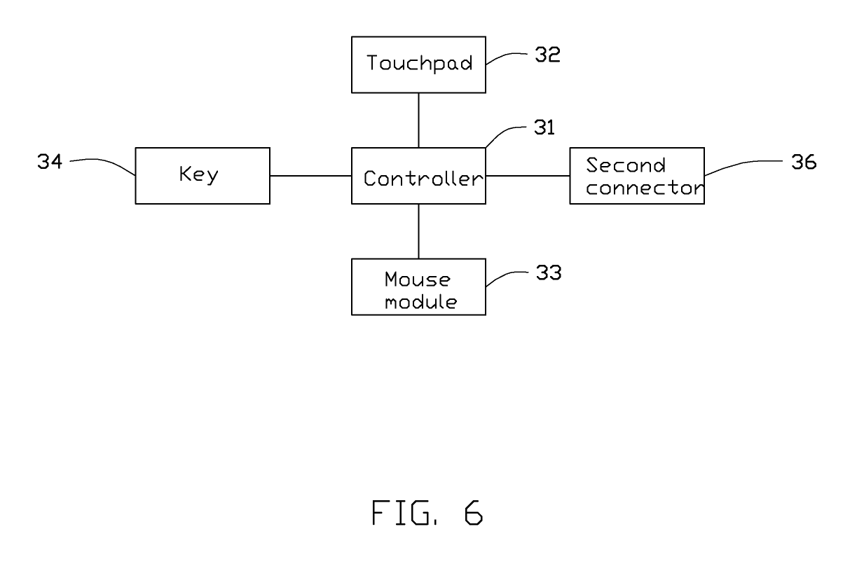

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

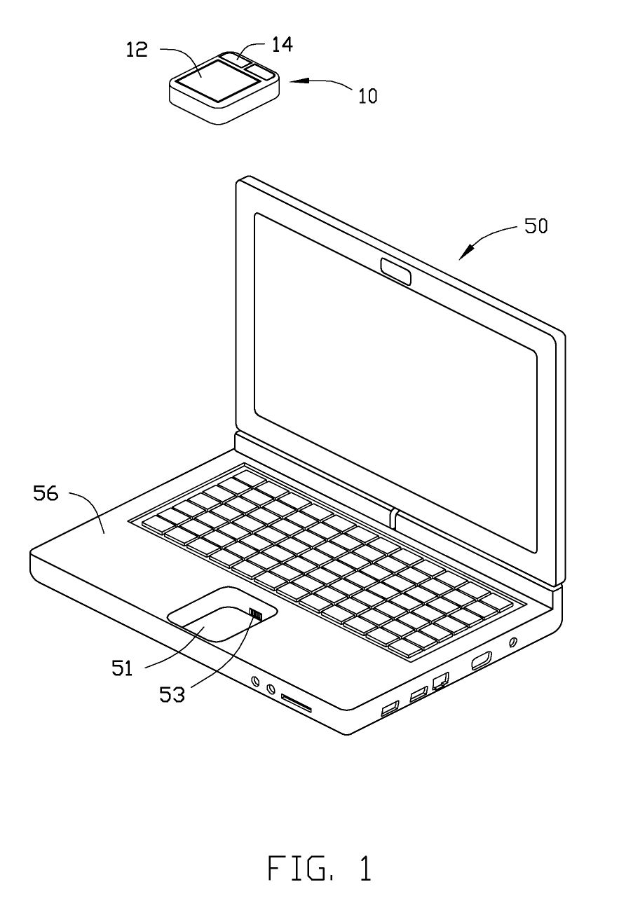

Referring to FIG. 1, an embodiment of an electronic device 50 includes a cursor controlling apparatus 10. The electronic device 50 includes a base 56. The base 56 defines a receiving recess 51 that is capable of receiving the cursor controlling apparatus 10 therein. A first connector 53 is located in the receiving recess 51.

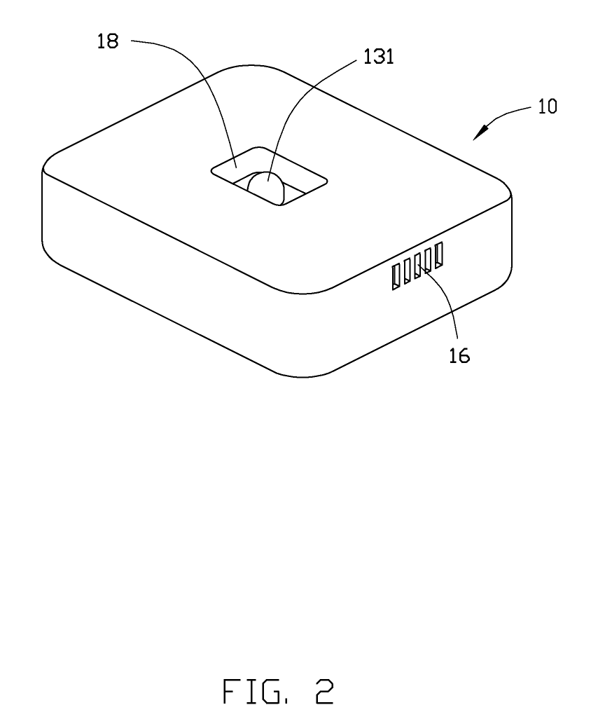

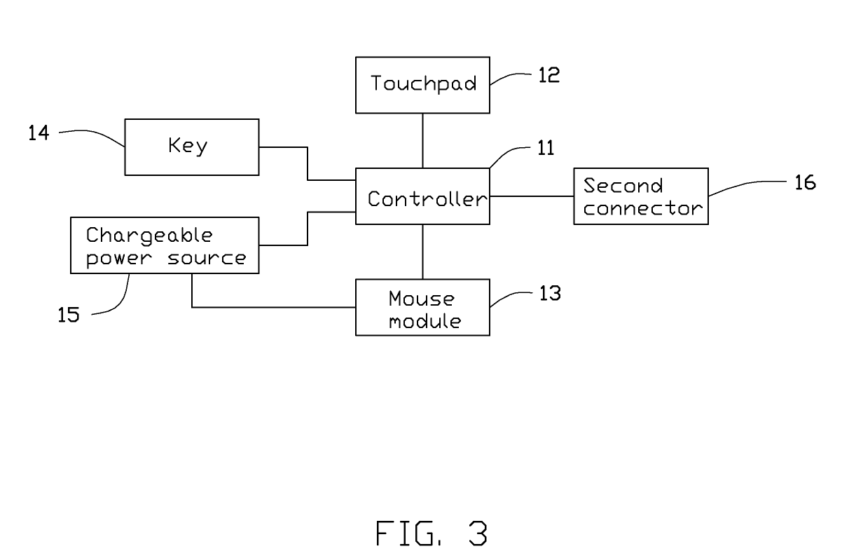

Referring to FIGS. 1 to 3, the cursor controlling apparatus 10 includes a controller 11, a touchpad 12, a mouse module 13, two keys 14, a chargeable power source 15, and a second connector 16. The mouse module 13 uses wireless technology and can be, for example, optical or laser type mouse that communicates with the electronic device 50 via wireless communication. The touchpad 12, the mouse module 13, the keys 14, the chargeable power source 15, and the second connector 16 are respectively connected to the controller 11. The chargeable power source 15 is connected to the mouse module 13 to provide power to the mouse module 13. The second connector 16 is connected to the chargeable power source 15 via the controller 11 to charge the chargeable power source 15 when the second connector 16 is connected to the first connector 53 of the electronic device 50.

The touchpad 12 and keys 14 are positioned on a top portion of the cursor controlling apparatus 10 for convenient access by users. The mouse module 13 is mounted in the cursor controlling apparatus 10. A bottom side of the cursor controlling apparatus 10 defines an opening 18. A light emitting component 131 of the mouse module 13 emits light out via the opening 18 to detect movement of the mouse module 13 on a surface.

The controller 11 is capable of controlling a work mode of the cursor controlling apparatus 10. When the controller 11 detects the second connector 16 is connected to the first connector 53 (i.e. the apparatus 10 is in the recess 51), the controller 11 enables the touchpad 12 and disables the mouse module 13 to work in a touchpad mode. The touchpad 12 can communicate with the electronic device 50 via the first and second connectors 53, 16 to control movement of a cursor on a display of the electronic device 50. When the controller 11 detects the second connector 16 is disconnected from the first connector 53 (i.e. the apparatus 10 has been removed from the recess 11), the controller enables the mouse module 13 and disables the touchpad 12 to work in a mouse mode. Then, a user handles the apparatus 10 as they would any mouse and the mouse module 13 can communicate with the electronic device 50 via the first and second connectors 53, 16 to control movement of a cursor on the display of the electronic device 50. In mouse mode, the chargeable power source 15 provides power to the mouse module 13.

The keys 14 are used to emulate functions of left and right keys of a normal mouse.

To use the cursor controlling apparatus 10 in touchpad mode, the cursor controlling apparatus 10 is put in the receiving recess 51. The second connector 16 of the cursor controlling apparatus 10 is connected to the first connector 53. The controller 11 detects the connection of the first and second connectors 16, 53, thereby enabling the touchpad 12 and disabling the mouse module 13. Simultaneously, the electronic device 50 charges the chargeable power source 15 via the first and second connectors 16, 53.

To use the cursor controlling apparatus 10 in mouse mode, the cursor controlling apparatus 10 is removed from the receiving recess 51, disconnecting the second connector 16 from the first connector 53. The controller 11 enables the mouse module 13 and disables the touchpad 12. The chargeable power source 15 provides power to the mouse module 13.

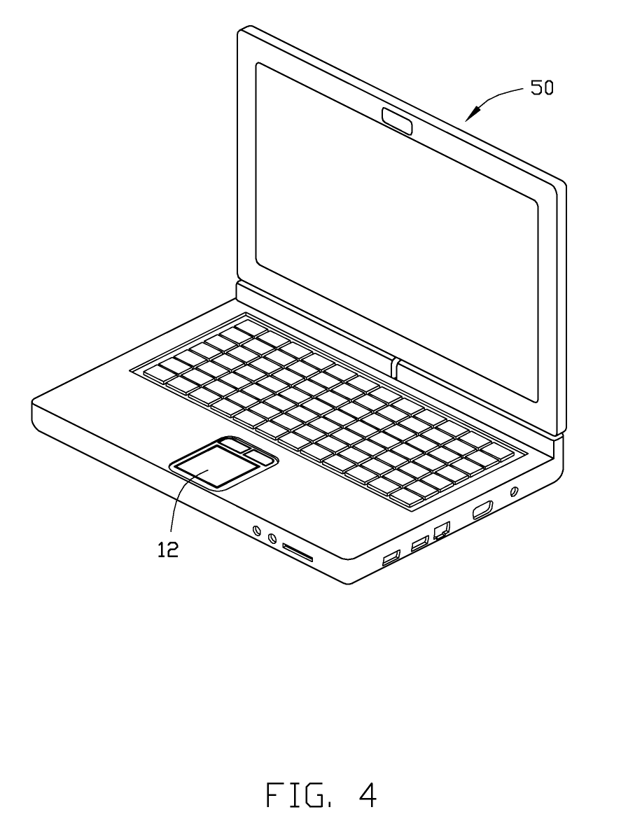

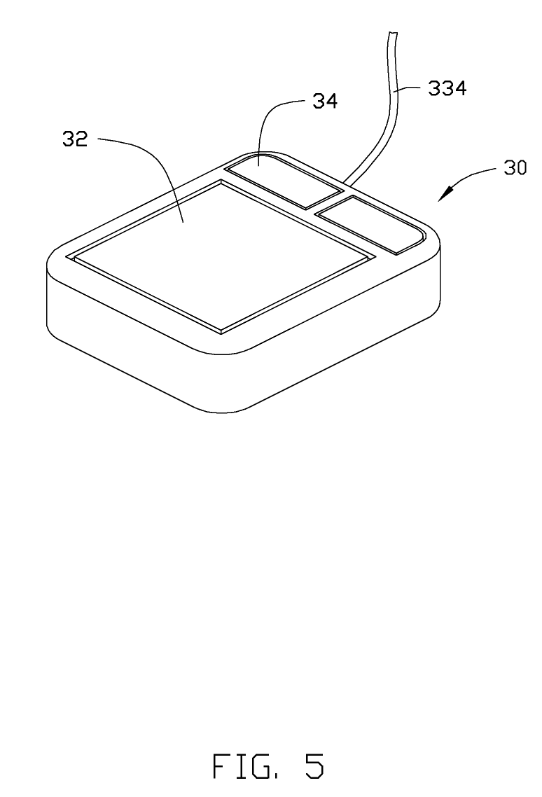

Referring to FIGS. 4 and 5, another embodiment of the cursor controlling apparatus 30 is shown. The cursor controlling apparatus 30 includes a controller 31, a touchpad 32, a mouse module 33, two keys 34, and a second connector 36. The cursor controlling apparatus 30 is similar to the cursor controlling apparatus 10, except that the mouse module 33 is a wire mouse and includes a wire 334, and does not need additional power source to provide power. The wire 334 is capable of communicating with the electronic device 50 when the cursor controlling apparatus 30 works in the mouse mode, and of being housed in the cursor controlling apparatus 30 when the cursor controlling apparatus 30 works in the touchpad mode.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An apparatus, the apparatus comprising:
an electronic device, comprising:
a cursor controlling apparatus, the cursor controlling apparatus detachably mounted to the electronic device, the cursor controlling apparatus comprising:
a touchpad mounted on a top portion of the cursor controlling apparatus;
a mouse module mounted in the cursor controlling apparatus; and
a controller connected to the touchpad and the mouse module, the controller capable of detecting whether the cursor controlling apparatus is mounted to the electronic device; wherein the controller enables the touchpad and disables the mouse module when the controller detects the cursor controlling apparatus is mounted to the electronic device; and the controller enables the mouse module and disables the touchpad when the controller detects the cursor controlling apparatus is not mounted to the electronic device.

2. The apparatus of claim 1, wherein the electronic device defines a receiving recess, and the cursor controlling apparatus is capable of being received in the receiving recess.

3. The apparatus of claim 2, further comprising a first connector located in the receiving recess, wherein the cursor controlling apparatus comprises a second connector capable of connecting with the first connector when the cursor controlling apparatus is received in the receiving recess, the controller is capable of detecting a connection between the first connector and the second connector.

4. The apparatus of claim 3, wherein the cursor controlling apparatus comprises a wireless module that capable of communicating with the electronic device via wireless means, the cursor controlling apparatus further comprises a chargeable power source capable of providing power to the wireless module, and the chargeable power source is charged when the first connector is connected to the second connector.

5. The apparatus of claim 1, wherein a plurality of keys are positioned on the top portion of the cursor controlling apparatus.

6. The apparatus of claim 1, wherein the mouse module is optical type and comprises a light emitting component, and a bottom side of the cursor controlling apparatus defines an opening via which the light emitting component emits light.

7. The apparatus of claim 1, wherein the cursor controlling apparatus further comprises a wire that communicates with the electronic device when the cursor controlling apparatus is not mounted to the electronic device.

8. An electronic device, comprising:
a base defining a receiving recess therein, a first connector located in the receiving recess;
a cursor controlling apparatus capable of detachably mounted in the receiving recess, the cursor controlling apparatus comprising a touchpad, a mouse module, and a second connector capable of connecting to the first connector when the cursor controlling apparatus is mounted in the receiving recess; wherein the touchpad is enabled and the mouse module is disenabled when the second connector is connected to the first connector; the mouse module is enabled and the touchpad is disenabled when the second connector is not connected to the first connector.

9. The electronic device of claim 8, wherein the cursor controlling apparatus comprises a wireless module that capable of communicating with the electronic device via wireless means; the cursor controller apparatus further comprises a chargeable power source capable of providing power to the wireless module, and the chargeable power source is capable of being charged when the first connector is connected to the second connector.

10. The electronic device of claim 8, wherein a plurality of keys are positioned on a top portion of the cursor controlling apparatus.

11. The electronic device of claim 8, wherein the mouse module is an optical mouse and comprises a light emitting component, and a bottom side of the cursor controlling apparatus defines an opening via which the light emitting component emits light.

12. The electronic device of claim 8, wherein the cursor controlling apparatus further comprises a wire that communicates with the electronic device when the controller enables the mouse module when the second connector is not connected to the first connector.
